(19) United States
(12) Patent Application Publication
(10) Pub. No.: US 2022/0234904 A1
(43) Pub. Date: Jul. 28, 2022

(54) HOLLOW NANO-PARTICLE, HOLLOW SILICA NANO-PARTICLE, AND PRODUCTION METHOD FOR SAME

(71) Applicant: DIC Corporation, Tokyo (JP)

(72) Inventors: Jianjun Yuan, Sakura-shi (JP); Hiroshi Kinoshita, Sakura-shi (JP); Hisakazu Tanaka, Sakura-shi (JP); Yukie Uemura, Takaishi-shi (JP)

(73) Assignee: DIC Corporation, Tokyo (JP)

(21) Appl. No.: 17/617,720

(22) PCT Filed: Jul. 8, 2020
(86) PCT No.: PCT/JP2020/026650

§ 371 Date: Dec. 9, 2021

(30) Foreign Application Priority Data
Jul. 16, 2019 (JP) 2019-131356

(51) Int. Cl. C01B 33/152; C01B 33/157

(52) U.S. Cl. CPC C01B 33/152; C01B 33/157; C01P 2004/34; C01P 2004/64; C01P 2004/62

(57) ABSTRACT

A hollow nano-particle includes a shell layer containing a block copolymer having a hydrophobic organic chain and a polyamine chain, and silica. A hollow silica nano-particle has a porosity of 20% by volume or more and 70% by volume or less, and a thickness of a shell layer containing silica of 3 nm or more and 100 nm or less. A production method for the hollow nano-particle includes: a step of dropping an aqueous solvent while stirring an organic solvent in which a block copolymer having a hydrophobic organic chain and a polyamine chain is dissolved, to obtain a dispersion liquid of vesicles containing the block copolymer; and a step of adding a silica source to the dispersion liquid of vesicles, carrying out a sol-gel reaction of the silica source using the vesicle as a template, and precipitating silica to obtain the hollow nano-particle.

### TECHNICAL FIELD

The present invention relates to a hollow nano-particle, a hollow silica nano-particle, and a production method for the same.

### BACKGROUND ART

In recent years, nanomaterials having a hollow structure have attracted attention. In particular, a hollow silica nano-particle having a shell containing silica has properties such as low refractive index, low dielectric constant, low thermal conductivity, and low density, and can be used as antireflection materials, low dielectric materials, heat insulating materials, low density fillers, and the like. Further, by utilizing a cavity inside a particle, a target substance can be encapsulated or slowly released to impart various functions. For example, research on drug delivery systems using the hollow silica nano-particle is being actively conducted.

Synthesis of hollow silica particles can be roughly divided into an interfacial reaction method and a template method. The interfacial reaction method designs a gas/liquid or liquid/liquid interface and precipitates silica at the interface. For example, a method for producing a hollow silica powder by carrying out a sol-gel reaction after mixing and spraying a silica source and a foaming agent is disclosed (see, for example, PTL 1). However, the average particle diameter of the hollow silica particles obtained by this method is several microns to several hundred microns, and it is difficult to synthesize nano-order hollow silica particles.

On the other hand, the template method is a method of obtaining the hollow silica particles by forming a silica shell on a surface of particles containing a substance other than silica and then selectively removing only a core material. In this method, the hollow silica nano-particle can be suitably produced by using a nano-sized template. As a core particle serving as the template, those containing an inorganic compound and those containing an organic polymer can be used. As a method using the template containing the inorganic compound, for example, a method for producing the hollow silica nano-particle by forming the silica shell on a surface of nano-particle such as calcium carbonate, zinc oxide, and iron oxide, and then by dissolving and removing a core with an acid is disclosed (see, for example, PTLs 2 and 3). However, the template containing the inorganic compounds is basically a crystal, and has a problem that true spherical hollow silica nano-particle cannot be synthesized.

Compared with the core particle (nano-particle) containing the inorganic compound, the nano-particle containing the organic polymer is advantageous in that the shape, particle diameter, structure, chemical composition and the like of the particle can be easily controlled. For example, a production method for the hollow silica nano-particle is disclosed (see, for example, PTL 4) in which a copolymer (A) having an aliphatic polyamine chain (a1) and a hydrophobic organic segment (a2) is mixed with an aqueous solvent, an aggregate including a core layer containing the hydrophobic organic segment (a2) as a main component and a shell layer containing the aliphatic polyamine chain (a1) as the main component is formed, a silica source (b) is added to the aqueous solvent containing the aggregate, the sol-gel reaction of the silica source is carried out using the aggregate as the template, a core-shell type silica nano-particle is obtained by precipitating silica (B), and then the copolymer (A) is removed from the obtained core-shell type silica nano-particle. Further, for example, a composition containing the core-shell type nano-particle that contains a cationic core material containing a polymer and a shell material containing silica is disclosed (see, for example, PTL 5), and the hollow silica nano-particle can be obtained by firing the core-shell type nano-particle. Furthermore, a method has also been reported in which the hollow silica particles having an average particle diameter of 100 nm or more are produced by subjecting the surface of the particles to the sol-gel reaction using polymer latex nano-particle and then removing core polymer by firing or solvent extraction (see, for example, NPL 1).

However, with the methods described in PTLs 4 and 5, only the hollow silica nano-particle having an average particle diameter of 10 nm or 30 nm or less can be obtained, and the porosity is low, so that original characteristics of hollow cannot be fully utilized. Further, in the method described in NPL 1, only the hollow silica nano-particle having an average particle diameter of 100 nm or more can be obtained, and the porosity is high, but the shell layer containing silica is thin and the mechanical strength is weak, and thus it is difficult to put it into practical use.

### CITATION LIST

### Patent Literature

PTL 1: JP-A-6-091194
PTL 2: JP-A-2005-263550
PTL 3: JP-A-2010-030791
PTL 4: JP-A-2014-076935
PTL 5: JP-T-2010-502795 (the term “JP-T” as used herein means a published Japanese translation of a PCT patent application)

### Non Patent Literature

NPL 1: Pi M et al., “Biomimetic synthesis of raspberry-like hybrid polymer-silica core-shell nanoparticles by templating colloidal particles with hairy polyamine shell.”, Colloids and Surfaces B: Biointerfaces, Vol. 78, Issue 2, p 193-199, 2010.

### SUMMARY OF INVENTION

### Technical Problem

The present invention has been made in view of the above circumstances, and provides the hollow nano-particle and the hollow silica nano-particle having excellent monodispersity, a high porosity of 20% by volume or more, and an average particle diameter of nano order, and the production method for the same.

### Solution to Problem

That is, the present invention includes the following aspects.
(1) A hollow nano-particle including a shell layer containing a block copolymer having a hydrophobic organic chain and a polyamine chain, and silica.
(2) The hollow nano-particle according to (1), having a porosity of 20% by volume or more and 70% by volume or less.
(3) The hollow nano-particle according to (1) or (2), having an average particle diameter of 20 nm or more and 1000 nm or less.
(4) The hollow nano-particle according to any one of (1) to (3), having a thickness of the shell layer of 3 nm or more and 100 nm or less.
(5) A hollow silica nano-particle having a porosity of 20% by volume or more and 70% by volume or less, and a thickness of a shell layer containing silica of 3 nm or more and 100 nm or less.
(6) The hollow silica nano-particle according to (5), having an average particle diameter of 20 nm or more and 1000 nm or less.
(7) A production method for the hollow nano-particle according to any one of (1) to (4), the production method including: a step of dropping an aqueous solvent while stirring an organic solvent in which a block copolymer having a hydrophobic organic chain and a polyamine chain is dissolved, to obtain a dispersion liquid of vesicles containing the block copolymer; and a step of adding a silica source to the dispersion liquid of vesicles, carrying out a sol-gel reaction of the silica source using the vesicle as a template, and precipitating silica to obtain the hollow nano-particle.
(8) A production method for the hollow silica nano-particle according to (5) or (6), the production method including: a step of dropping an aqueous solvent while stirring an organic solvent in which a block copolymer having a hydrophobic organic chain and a polyamine chain is dissolved, to obtain a dispersion liquid of vesicles containing the block copolymer; a step of adding a silica source to the dispersion liquid of vesicles, carrying out a sol-gel reaction of the silica source using the vesicle as a template, and precipitating silica to obtain a hollow nano-particle; and a step of removing the block copolymer from the hollow nano-particle.
(9) The production method according to (8), wherein removal of the block copolymer is by firing.

### Advantageous Effects of Invention

According to the hollow nano-particle, the hollow silica nano-particle, and the production method for the same of the above aspects, it is possible to provide the hollow nano-particle and the hollow silica nano-particle having excellent monodispersity, a high porosity of 20% by volume or more, and an average particle diameter of nano order.

### BRIEF DESCRIPTION OF DRAWINGS

FIG. 1 is a cross-sectional view of a hollow nano-particle according to an embodiment of the present invention.

FIG. 2 is a cross-sectional view of a hollow silica nano-particle according to the embodiment of the present invention.

FIG. 3 is a schematic configuration diagram illustrating a production method for the hollow nano-particle and the hollow silica nano-particle according to the embodiment of the present invention.

FIG. 4 is a transmission electron microscope image of the hollow nano-particle in Example 1.

### DESCRIPTION OF EMBODIMENT

Hereinafter, a hollow nano-particle, a hollow silica nano-particle, and a production method for the same according to an embodiment of the present invention will be described in detail.

### <Hollow Nano-Particle>

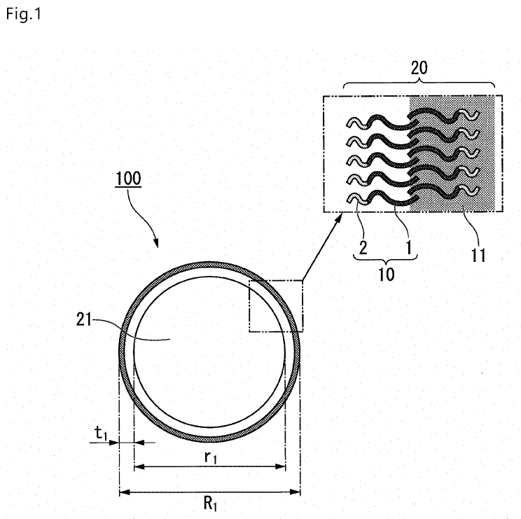

FIG. 1 is a cross-sectional view of the hollow nano-particle according to the embodiment of the present invention.

A hollow nano-particle 100 includes a shell layer 20 containing a block copolymer 10 and silica 11, and an inside covered with the shell layer 20 is a cavity 21 and has a hollow structure. Further, the block copolymer 10 has a hydrophobic organic chain 1 and a polyamine chain 2. Since the hollow nano-particle 100 contains the block copolymer 10 and the silica 11 in the shell layer, it is easily adapted when mixed with a resin, and it has a hybrid structure at a molecular level containing the block copolymer 10 and the silica 11 in the shell layer 20, and has higher mechanical strength than a hollow particle containing only silica.

The porosity of the hollow nano-particle 100 is preferably 20% by volume or more, more preferably 20% by volume or more and 70% by volume or less, still more preferably 20% by volume or more and 60% by volume or less, particularly preferably 20% by volume or more and 50% by volume or less, and most preferably 22% by volume. When the porosity is at least the above lower limit value, the refractive index and the dielectric constant can be made lower and the weight can be made lighter. On the other hand, when it is not more than the above upper limit value, the mechanical strength of the hollow nano-particle can be made better.

Note that the porosity is a ratio of a volume of a void to a volume of the hollow nano-particle, and can be calculated by using, for example, a method described below. First, a particle diameter (an outer diameter) R1 and a thickness t₁ are measured from a transmission electron microscope (TEM) image of the hollow nano-particle. Subsequently, a volume Vₓ₁ of the hollow nano-particle and a volume Vₓ₂ of the void are respectively calculated using the following formulas.

$${V}_{x 1} = \{ 4 \times Π \times {( {R}_{1} / 2 )}^{3} \} / 3$$

$${V}_{x 2} = \{ 4 \times Π \times {( {R}_{1} / 2 - {t}_{1} )}^{3} \} / 3$$

From the volume Vₓ₁ of the obtained hollow nano-particle and the volume Vₓ₂ of the void, the porosity (volume %) can be calculated using the following formula.

$$Porosity ( volume \% ) = {V}_{x 2} / {V}_{x 1} \times 100$$

An average value of the particle diameter R₁ (that is, an average particle diameter) of the hollow nano-particle 100 is preferably 20 nm or more and 1000 nm or less, more preferably 20 nm or more and 500 nm or less, still more preferably 20 nm or more and 300 nm or less, particularly preferably 20 nm or more and 100 nm or less, and most preferably 50 nm. When the average particle diameter is at least the above lower limit, the porosity can be kept higher. On the other hand, when it is not more than the above upper limit value, the mechanical strength of the hollow nano-particle can be made better.

The particle diameter R₁ and t₁ of the hollow nano-particle 100 can be measured from, for example, the TEM image, and the average value (average particle diameter) of the particle diameter R₁ and the average value of the thickness t₁ can be obtained by calculating the average value of measured values of the particle diameter R₁ of a plurality of (for example, about 100 or more and 500 or less) hollow nano-particles by using known image analysis software. Alternatively, the average particle diameter can be estimated by measurement with small angle scattering (TTRII manufactured by Rigaku Corporation) and by NANO-Solver analysis of a scattering curve.

In the present specification, the “particle diameter” means the outer diameter of the particle having a hollow structure.

The thickness t₁ of the shell layer 20 of the hollow nano-particle 100 is preferably 3 nm or more and 100 nm or less, more preferably 3 nm or more and 50 nm or less, still more preferably 5 nm or more and 40 nm or less, particularly preferably 5 nm or more and 20 nm or less, and most preferably 10 nm. When the thickness t₁ of the shell layer 20 is at least the above lower limit value, the mechanical strength of the hollow nano-particle can be made better. On the other hand, when it is not more than the above upper limit value, the porosity can be kept higher.

The particle diameter R₁ and the thickness t₁ of the hollow nano-particle 100 are appropriately adjusted to be within a range of the above porosity. Details of a method for adjusting the particle diameter R₁ and the thickness t₁ will be described below.

### [Block Copolymer]

The block copolymer 10 contained in the shell layer 20 has the hydrophobic organic chain 1 and the polyamine chain 2.

The hydrophobic organic chain 1 is not particularly limited as long as it can be dissolved in an organic solvent to form a vesicle made of a double layer in which block copolymers 10 are arranged without gaps in an aqueous solvent, and examples of the hydrophobic organic chain 1 include a compound having a polyalkylene chain having 5 or more carbon atoms (preferably 10 or more carbon atoms), and a hydrophobic polymer such as polyacrylate, polystyrene, and polyurethane. The molecular weight of the hydrophobic organic chain 1 is not particularly limited as long as the vesicle can be stabilized in nano size, but the number of repeating units of a polymerization unit in the hydrophobic organic chain 1 is preferably 5 or more and 1000 or less, and more preferably 5 or more and 500 or less, because the vesicle can be suitably formed.

The polyamine chain 2 is not particularly limited as long as it can be dissolved in the aqueous solvent to form the vesicle made of the double layer in which the block copolymers 10 are arranged without gaps, and examples of the polyamine chain 2 include an acrylate-based polyamine chain, a branched polyethyleneimine chain, a linear polyethyleneimine chain, and a polyallylamine chain. The acrylate-based polyamine chain is preferred because a desired hollow nano-particle can be efficiently produced. Further, the molecular weight of the polyamine chain 2 is not particularly limited as long as it can form the vesicle in a balanced manner with the hydrophobic organic chain 1, but the number of repeating units of the polymerization unit in the polyamine chain 2 is preferably 5 or more and 1000 or less, and more preferably 5 or more and 100 or less, because the vesicle can be suitably formed.

The molecular structure of the polyamine chain 2 is also not particularly limited, and examples thereof include a linear chain, a branched chain, a dendrimer, a star, and a comb. A linear acrylate-based polyamine chain is preferred because the vesicle used as the template for silica precipitation can be efficiently formed and production cost can be reduced.

Skeleton of the polyamine chain 2 may include only one type of amine polymerization unit, or may be a polyamine chain (copolymer) containing copolymerization of two or more types of amine units. Further, in the skeleton of the polyamine chain 2, the polymerization unit other than the amine may be present as long as the vesicle can be formed in the aqueous solvent. From the viewpoint of suitably forming the vesicle, a ratio of other polymerization units in the amine skeleton of the polyamine chain 2 is preferably 50 mol % or less, more preferably 30 mol % or less, still more preferably 15 mol % or less.

A ratio of the hydrophobic organic chain 1 and the polyamine chain 2 in the block copolymer 10 is not particularly limited as long as a stable vesicle can be formed in the aqueous solvent. The ratio of the polyamine chain 2 to the hydrophobic organic chain 1 is preferably 5/100 or more and 80/100 or less, more preferably 10/100 or more and 70/100 or less, still more preferably 15/100 or more and 60/100 or less, particularly preferably 20/100 or more and 30/100 or less, and most preferably 21/100 or more and 23/100 or less in terms of mass ratio, because the vesicle can be easily formed.

Further, the number average molecular weight of the block copolymer 10 is preferably 2000 or more and 100,000 or less, more preferably 2500 or more and 80,000 or less, still more preferably 5000 or more and 50,000 or less, particularly preferably 6000 or more and 30,000 or less, and most preferably 6800 or more and 7200 or less.

The weight average molecular weight of the block copolymer 10 is preferably 2000 or more and 100,000 or less, more preferably 25,000 or more and 80,000 or less, still more preferably 5000 or more and 50,000 or less, particularly preferably 6000 or more and 30,000 or less, and most preferably 8000 or more and 8300 or less.

By using the block copolymer 10 having the number average molecular weight and the weight average molecular weight in the above ranges, the thickness t₁ of the hollow nano-particle 100 can be controlled to 3 nm or more and 100 nm or less, and the hollow nano-particle 100 having a high porosity of 20% by volume or more can be obtained.

Note that the number average molecular weight and the weight average molecular weight of the block copolymer 10 can be measured by using a gel permeation chromatography (GPC) method. As a specific measurement method, a method described in Examples described below can be employed.

The block copolymer 10 can be obtained by using a known living polymerization. As the living polymerization, for example, living radical polymerization can be used, such as living anionic polymerization, living cationic polymerization, atom transfer radical polymerization (ATRP), nitroxide living radical polymerization (NMP), reversible addition cleavage chain transfer (RAFT) polymerization, and organic tellurium-mediated living radical polymerization (TERP). Among them, the living anionic polymerization is preferred because the molecular weight can be controlled most precisely. As a method for obtaining the block polymer 10 by using the living anionic polymerization, for example, a method described in Reference 1 (WO2015/041146) or the like can be used. Specifically, first, a first polymerizable monomer constituting the hydrophobic organic chain 1 is subjected to the living anionic polymerization in the presence of a polymerization initiator, to obtain a polymer block (A) derived from the first polymerizable monomer. Subsequently, diphenylethylene or α-methylstyrene is reacted to a growth end of the polymer block (A), to obtain an intermediate polymer in which a polymerization unit (B) derived from diphenylethylene or α-methylstyrene is bonded to one end of the polymer block (A). Subsequently, the polymerization unit (B) derived from diphenylethylene or α-methylstyrene contained in the intermediate polymer is used as the growth end, and further a second polymerizable monomer constituting the polyamine chain 2 is subjected to the living anionic polymerization in the presence of the polymerization initiator, to form a polymer block (C) derived from the second polymerizable monomer to obtain the block copolymer 10. These reactions can be carried out using a microreactor having a flow channel capable of mixing a plurality of liquids.

Examples of the first polymerizable monomer include styrene or a derivative thereof (excluding diphenylethylene and α-methylstyrene).

Examples of the styrene derivative include p-dimethylsilylstyrene, p-vinylphenyl methyl sulfide, p-hexynylstyrene, p-methoxystyrene, p-tert-butyldimethylsiloxystyrene, o-methylstyrene, p-methylstyrene, and p-tert-butylstyrene. These styrene derivatives may also be used in combination with styrene, and the styrene derivatives may be used alone or in combination of two or more. Note that in the following, when simply referring to “styrene”, it is assumed that the concept includes styrene derivatives other than diphenylethylene and α-methylstyrene (however, the description in Examples and Comparative Example is excluded).

Examples of the second polymerizable monomer include a (meth)acrylate compound (c) having an alkylamino group (hereinafter, may be simply abbreviated as “(meth)acrylate compound (c)”).

Examples of the (meth)acrylate compound (c) include dimethylaminoethyl (meth) acrylate, diethylaminoethyl (meth) acrylate, and dimethylaminopropyl (meth) acrylate. These (meth)acrylate compounds (c) having the alkylamino group can be used alone or in combination of two or more.

Note that in this specification, “(meth)acrylate” means one or both of methacrylate and acrylate.

When the (meth)acrylate compound (c) is polymerized, another (meth)acrylate compound or conjugated monomers such as acrylonitrile, 1,3-butadiene, isoprene, or vinylpyridine may be used in combination.

Examples of other (meth)acrylate compounds include: alkyl (meth)acrylates such as methyl (meth)acrylate, ethyl (meth)acrylate, n-butyl (meth)acrylate, sec-butyl (meth) acrylate, tert-butyl (meth) acrylate, isopropyl (meth) acrylate, isobutyl (meth) acrylate, 2-ethylhexyl (meth)acrylate, decyl (meth)acrylate, undecyl (meth)acrylate, dodecyl (meth)acrylate (lauryl (meth)acrylate), tridecyl (meth) acrylate, pentadecyl (meth) acrylate, hexadecyl (meth) acrylate, heptadecyl (meth) acrylate, octadecyl (meth)acrylate (stearyl (meth)acrylate), nonadecyl (meth)acrylate, and icosanyl (meth)acrylate; aromatic (meth)acrylates such as benzyl (meth)acrylate and phenylethyl (meth)acrylate; (meth)acrylates having an alicyclic structure such as cyclohexyl (meth)acrylate and isobornyl (meth)acrylate; alkyl group-terminated polyalkylene glycol mono (meth)acrylates such as methoxypolyethylene glycol mono (meth)acrylate, methoxypolypropylene glycol mono (meth)acrylate, octoxypolyethylene glycol mono (meth)acrylate, octoxypolypropylene glycol mono (meth)acrylate, lauroxypolyethylene glycol mono (meth)acrylate, lauroxypolypropylene glycol mono (meth)acrylate, stearoxypolyethylene glycol mono (meth)acrylate, stearoxypolypropylene glycol mono (meth)acrylate, allyloxypolyethylene glycol mono (meth)acrylate, allyloxypolypropylene glycol mono (meth)acrylate, nonylphenoxypolyethylene glycol mono (meth)acrylate, and nonylphenoxypolypropylene glycol mono (meth) acrylate; silane-based (meth)acrylates such as trimethylsiloxyethyl (meth)acrylate; (meth)acrylates having a siloxy group such as dialkylsiloxy group, diphenylsiloxy group, trialkyl syroxy group, and triphenyl syroxy group; (meth)acrylates having cage-type silsesquioxane group; fluorine-based (meth)acrylates such as perfluoroalkylethyl (meth)acrylate; and (meth)acrylate compounds such as glycidyl (meth)acrylate, epoxy (meth)acrylate, ethylene glycol di(meth)acrylate, diethylene glycol di(meth)acrylate, trimethylolpropane tri(meth)acrylate, tetramethylene glycol tetra(meth)acrylate, 2-hydroxy-1,3-diacryloxypropane, 2,2-bis[4-(acryloxymethoxy)phenyl]propane, 2,2-bis[4-(acryloxyethoxy)phenyl]propane, dicyclopentenyl (meth)acrylate tricyclodecanyl (meth) acrylate, tris(acryloxyethyl) isocyanurate, and urethane (meth)acrylate. These other (meth)acrylate compounds may be used alone or in combination of two or more.

Further, examples of the perfluoroalkylethyl (meth)acrylate include 2-(perfluorobutyl)ethyl(meth)acrylate, 2-(perfluorohexyl)ethyl(meth)acrylate, and 2-(perfluorooctyl)ethyl(meth)acrylate.

In a method for producing the block copolymer, a first step is a step of subjecting a solution containing styrene to the living anionic polymerization in the presence of the polymerization initiator to obtain a polymer block (A) derived from styrene, and then reacting the solution with diphenylethylene or α-methylstyrene. Through this step, the intermediate polymer in which the polymerization unit (B) derived from α-methylstyrene is bonded to one end of the polymer block (A) derived from styrene can be obtained. Further, in the first step, when α-methylstyrene is used, a mixed solution of styrene and α-methylstyrene may be subjected to the living anionic polymerization in the presence of the polymerization initiator, to obtain the intermediate polymer in which the polymerization unit (B) derived from α-methylstyrene is bonded to one end of the polymer block (A) derived from styrene.

Next, in a second step, the polymerization unit (B) derived from diphenylethylene or α-methylstyrene contained in the intermediate polymer obtained in the first step is used as the growth end, and further the (meth)acrylate compound (c) is subjected to the living anionic polymerization in the presence of the polymerization initiator, to form the polymer block (C) derived from the (meth)acrylate compound to obtain a desired block copolymer 10.

During the above-mentioned living anionic polymerization, by the presence of one or more additives selected from the group consisting of lithium chloride, lithium perchlorate, N, N, N′, N′-tetramethylethylenediamine and pyridine in addition to styrene, diphenylethylene or α-methylstyrene and the polymerization initiator, the living anionic polymerization, which normally needs to be performed at low temperatures, can be performed in an industrially manufacturable temperature range. Here, it is considered that the additives have a function of preventing nucleophilic reaction of the polymerization initiator (anion) on the ester bond present in the structure of the above-mentioned polymerizable monomer or the structure of the polymer obtained by the polymerization reaction. Further, an amount of the additives used can be appropriately adjusted according to an amount of the polymerization initiator, but the amount of the additives is preferably 0.05 mol or more and 10 mol or less, and more preferably 0.1 mol or more and 5 mol or less with respect to 1 mol of the polymerization initiator since polymerization reaction rate is increased and the molecular weight of the produced polymer can be easily controlled.

The above-mentioned styrene, diphenylethylene or α-methylstyrene, (meth)acrylate compound and polymerization initiator are preferably diluted or dissolved with the organic solvent and used in the reaction as the solution.

Examples of the organic solvent include hydrocarbon solvents such as pentane, hexane, octane, cyclohexane, benzene, toluene, xylene, decalin, tetralin, and derivatives thereof; and ether solvents such as diethyl ether, tetrahydrofuran (THF), 1,4-dioxane, 1,2-dimethoxyethane, diethylene glycol dimethyl ether, and diglyme. The organic solvents can be used alone or in combination of two or more.

When the mixed solution of styrene and α-methylstyrene used in the first step is diluted with the organic solvent, the concentration in the mixed solution of styrene is preferably 0.5 M or more and 8 M or less, more preferably 1 M or more and 7 M or less, and still more preferably 2 M or more and 6 M or less, because the yield of the block copolymer per unit time can be efficiently increased. Note that “M” represents mol/L, and the same applies hereinafter.

Further, the concentration of α-methylstyrene in the mixed solution, when the mixed solution of styrene and α-methylstyrene used in the first step is diluted with the organic solvent, can be appropriately adjusted according to the number of repeating units of the polymerization unit (B) derived from α-methylstyrene in the block copolymer to be obtained. For example, when the average number of repeating units is 1, the concentration of α-methylstyrene in the mixed solution is adjusted so that the number of moles is the same as the number of moles of the polymerization initiator in the reaction solution. The number of repeating units is preferably 1 or more in order to replace all reaction ends of styrene with α-methylstyrene, more preferably 1 or more and 5 or less, and still more preferably 1 or more and 3 or less in consideration of the reaction rate of α-methylstyrene.

On the other hand, when the (meth)acrylate compound (c) used in the second step is diluted with the solution of the organic solvent, considering the balance between mixability with the solution of the intermediate polymer obtained in the first step and the yield of the polymer per unit time, the concentration of the (meth)acrylate compound (c) is preferably 0.5M or more, more preferably 1M or more and 6M or less, and still more preferably 2M or more and 5M or less.

Organolithium can be used as the polymerization initiator, and examples of the organolithium include: alkyl lithium such as methyllithium, ethyl lithium, propyl lithium, butyl lithium (n-butyl lithium, sec-butyl lithium, isobutyl lithium, tert-butyl lithium, and the like), pentyl lithium, and hexyl lithium; alkoxyalkyl lithium such as methoxymethyl lithium and ethoxymethyl lithium; α-methylstyryl lithium; diarylalkyl lithium such as 1,1-diphenylhexyllithium, 1,1-diphenyl-3-methylpentryl lithium, and 3-methyl-1,1-diphenylpentyl lithium; alkenyl lithium such as vinyl lithium, allyl lithium, propenyl lithium, and butenyl lithium; alkynyl lithium such as ethynyl lithium, butynyl lithium, pentynyl lithium, and hexynyl lithium; aralkyl lithium such as benzyl lithium and phenylethyl lithium; aryl lithium such as phenyl lithium and naphthyl lithium; heterocyclic lithium such as 2-thienyl lithium, 4-pyridyl lithium, and 2-quinolyl lithium; and alkyl lithium magnesium complexes such as tri(n-butyl)magnesium lithium and trimethyl magnesium lithium. Among them, the alkyl lithium is preferred because it can efficiently proceed with the polymerization reaction, and among the alkyl lithium, n-butyl lithium or sec-butyl lithium is preferred. In addition, n-butyl lithium is more preferred because it is easily commercially available and highly safe. The polymerization initiators can be used alone or in combination of two or more.

The concentration of the polymerization initiator in the organic solvent solution is preferably 0.01 M or more, more preferably 0.05 M or more and 3 M or less, and still more preferably 0.05 M or more and 2 M or less, because the yield of the polymer per unit time can be efficiently increased. Further, as the organic solvent for diluting or dissolving the polymerization initiator to make the solution, hydrocarbon-based solvent is preferred, such as hexane, cyclohexane, benzene, toluene and xylene in consideration of solubility of the polymerization initiator and stability of polymerization initiator activity.

When the solution of the polymerizable monomer such as styrene and the polymerization initiator is introduced into the flow channel of the microreactor at a high concentration, in order to smoothly proceed with the living anionic polymerization, it is necessary to reliably feed a solution of a polymer of a highly viscous polymerizable monomer formed by polymerization into the flow channel of the microreactor. In particular, when the intermediate polymer obtained in the first step and the (meth)acrylate compound (c) are subjected to the living anionic polymerization, high viscosity solution of the intermediate polymer obtained in the first step and low viscosity solution of (meth)acrylate compound differ greatly in their viscosities, however, it is necessary to be able to reliably mix them, carry out the living anionic polymerization, and reliably feed the solution of high-viscosity block copolymer produced. In this way, as a pump for reliably introducing the highly viscous solution into the flow channel of the microreactor, a pump capable of high-pressure liquid feeding and having a very small pulsating flow is preferred, and a plunger pump or a diaphragm type pump is preferred as such a pump.

Further, a liquid feeding pressure when introducing the solution of the polymerizable monomer such as styrene, the polymerization initiator, and the produced intermediate polymer, into the flow channel of the microreactor is preferably 2 MPa or more and 32 MPa or less, more preferably 3 MPa or more and 20 MPa or less, and still more preferably 4 MPa or more and 15 MPa or less, because the polymer can be efficiently produced. As a pump capable of feeding liquid at such a pressure, a plunger pump for liquid chromatography is preferred, and a double plunger pump is more preferred. Further, a method in which a damper is attached to an outlet of the double plunger pump to suppress the pulsating flow and feed the liquid is more preferred.

The microreactor used in the production of the block copolymer 10 includes the flow channel capable of mixing the plurality of liquids, but the microreactor having a heat transfer reaction vessel in which the flow channel is installed is preferred, the microreactor having the heat transfer reaction vessel having a microtubular flow channel formed therein is more preferred, and the microreactor having the heat transfer reaction vessel in which a heat transfer plate-like structures having a plurality of grooves formed on a surface thereof are laminated is particularly preferred.

The living anionic polymerization reaction can be carried out at a temperature of −78° C. or lower, which is a reaction temperature of the conventional batch method, but can also be carried out at a temperature of −40° C. or higher, which is an industrially feasible temperature, and can also be carried out at −28° C. or higher. The reaction temperature is preferably −40° C. or higher, because the polymer can be produced using a cooling device having a simple structure, and the production cost can be reduced. Further, when the temperature is −28° C. or higher, it is preferred because the polymer can be produced by using a cooling device having a simpler structure and the production cost can be significantly reduced.

As a preferred form of a micromixer system that mixes the solution of two or more kinds of polymerizable monomers or polymers, in order to introduce the solution into the flow channel of the microreactor at a higher concentration than the conventional method and smoothly proceed with the living anionic polymerization, a micromixer capable of mixing a high-concentration polymerizable monomer solution and a polymerization initiator solution in a short time is preferred.

The micromixer is the flow channel capable of mixing the plurality of liquids contained in the microreactor, but as the micromixer, a commercially available micromixer can be used, and examples of the micromixer include: a microreactor including an interdigital channel structure; a single mixer and a caterpillar mixer manufactured by Institut fur Microtechnik Mainz (IMM) GmbH; a micro glass reactor manufactured by Mikrogras Chemtech GmbH; Cytos manufactured by CPC Systems GmbH; Model YM-1 mixer and Model YM-2 mixer manufactured by Yamatake Corp.; Mixing Tee and Tee (T-shaped connector) manufactured by Shimadzu GLC Ltd.; IMT chip reactor manufactured by Institute of Microchemical Technology Co., Ltd.; and Micro High Mixer developed by Toray Engineering Co., Ltd., and any of them can be used.

Further, in the method for producing the block copolymer 10, by appropriately adjusting the reaction time and reaction temperature of the living anionic polymerization in the first step and the second step, and the types and blending ratio of the first polymerizable monomer and the second polymerizable monomer, the mass ratio of the hydrophobic organic chain 1 and the polyamine chain 2 in the block copolymer 10 to be obtained can be adjusted to be within the above range.

Further, the block copolymer 10 may be modified with molecules having various functions. The modification may be a modification to the hydrophobic organic chain 1 or a modification to the polyamine chain 2. For the modification of the block copolymer 10, any functional molecule may be introduced as long as the stable vesicle can be formed in the aqueous solvent, and silica is precipitated using the vesicle of the modified block copolymer 10 as the template, so that it is possible to obtain the hollow nano-particle into which any functional molecule has been introduced. From this point of view, it is particularly preferred to modify with a fluorescent compound, and when the fluorescent compound is used, the obtained hollow nano-particle also exhibits fluorescence and can be suitably used in various application fields.

Examples of the preferred block copolymer 10 include, compounds represented by the following formula (1), but are not limited thereto. In the formula (1), m/n is preferably 100/80 or more and 100/5 or less, more preferably 100/70 or more and 100/10 or less, still more preferably 100/60 or more and 100/15 or less, particularly preferably 100/20 or more and 100/30 or less, and most preferably 21/100 or more and 23/100 or less.

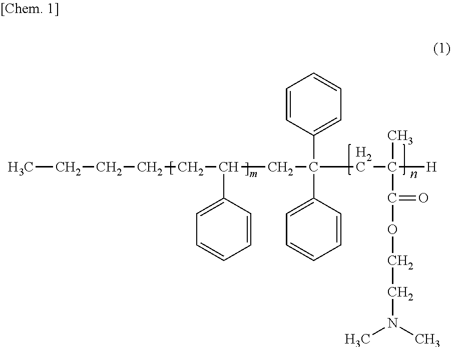

### [Silica]

The silica 11 contained in the shell layer 20 is formed by a sol-gel reaction of a silica source using the polyamine chain 2 contained in a shell layer 22 containing the block copolymer 10 as a catalyst and a scaffold. Examples of the silica source include water glass, tetraalkoxysilanes, and oligomers of tetraalkoxysilane.

Examples of tetraalkoxysilanes include tetramethoxysilane, tetraethoxysilane, tetrapropoxysilane, tetrabutoxysilane, and tetra-tert-butoxysilane.

Examples of the oligomers include a tetramer of tetramethoxysilane, a heptamer of tetramethoxysilane, a pentamer of tetraethoxysilane, and a decamer of tetraethoxysilane.

Further, the silica 11 may contain polysilsesquioxane in addition to those exemplified above. The polysilsesquioxane is a silicone resin derived from organic silane. Examples of the organic silane include alkyltrialkoxysilanes, dialkylalkoxysilanes, and trialkylalkoxysilanes.

Examples of alkyltrialkoxysilanes include methyltrimethoxysilane, methyltriethoxysilane, ethyltrimethoxysilane, ethyltriethoxysilane, n-propyltrimethoxysilane, n-propyltriethoxysilane, iso-propyltrimethoxysilane, iso-propyltriethoxysilane, 3-chloropropyltrimethoxysilane, 3-chloropropyltriethoxysilane, vinyltrimethoxysilane, vinyltriethoxysilane, 3-glycitoxypropyltrimethoxysilane, 3-glycitoxypropyltriethoxysilane, 3-aminopropyltrimethoxysilane, 3-aminopropyltriethoxysilane, 3-mercaptopropyltomethoxysilane, 3-mercaptotriethoxysilane, 3,3,3-trifluoropropyltrimethoxysilane, 3,3,3-trifluoropropyltriethoxysilane, 3-methacryloxypropyltrimethoxysilane, 3-methacryloxypropyltriethoxysilane, phenyltrimethoxysilane, phenyltriethoxysilane, p-chloromethylphenyltrimethoxysilane, and p-chloromethylphenyltriethoxysilane.

Examples of the dialkylalkoxysilanes include dimethyldimethoxysilane, dimethyldiethoxysilane, diethyldimethoxysilane, and diethyldiethoxysilane.

Examples of trialkylalkoxysilanes include trimethylmethoxysilane and trimethylethoxysilane.

### <Production Method for Hollow Nano-Particle>

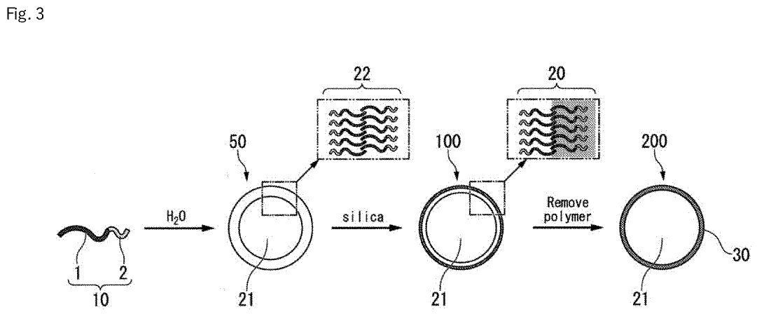

FIG. 3 is a schematic configuration diagram illustrating the production method for the hollow nano-particle and the hollow silica nano-particle according to the embodiment of the present invention. Hereinafter, the production method for the hollow nano-particle will be described in detail with reference to FIG. 3.

The hollow nano-particle can be obtained by, for example, a production method including the following steps (1) and (2).

(1) a step of dropping an aqueous solvent while stirring the organic solvent in which the block copolymer 10 having the hydrophobic organic chain 1 and the polyamine chain 2 is dissolved, to obtain a dispersion liquid of vesicles 50 containing the block copolymer
(2) a step of adding the silica source to the dispersion liquid of the vesicles 50, carrying out the sol-gel reaction of the silica source using the vesicle 50 as the template, and precipitating the silica 11 to obtain the hollow nano-particle 100

In the step (1), first, the block copolymer 10 is dissolved in the organic solvent. Examples of the organic solvent include those similar to those exemplified in the description of the method for producing the block copolymer 10. Subsequently, the aqueous solvent is dropped while stirring the organic solvent in which the block copolymer 10 is dissolved. Thus, the vesicle 50 having a hollow structure can be formed by self-organization. At this time, the particle diameter of the vesicle 50 to be obtained can be controlled by appropriately adjusting the concentration of the block copolymer 10 in the organic solvent, the volume ratio of the aqueous solvent to the organic solvent, the rate of dropping the aqueous solvent, and the stirring rate of the organic solvent. Further, since the silica 11 is precipitated using the vesicle 50 as the template in the step (2) described below, the average particle diameter of the hollow nano-particle 100 to be obtained can be controlled within the above range by controlling the particle diameter of the vesicle 50.

The shell layer 22 of the vesicle 50 contains the block copolymer 10 as a main component, and it is considered that the double layer in which due to the hydrophobic interaction between the hydrophobic organic chains 1, the hydrophobic organic chain 1 is inside the layer, and the hydrophilic polyamine chain 2 is outside the layer, is formed and self-organized, and thus the stable vesicle 50 is formed in the mixed solvent of the organic solvent and the aqueous solvent.

The aqueous solvent for forming the vesicle 50 is not particularly limited as long as it contains water and can form the stable vesicle 50, and examples thereof include water and a mixed solution of water and a water soluble solvent. When the mixed solution is used, an amount of water in the mixed solution can be 0.5/9.5 or more and 3/7 or less in terms of volume ratio of water/water soluble solvent, and is preferably 0.1/9.9 or more and 5/5 or less. From the viewpoint of productivity, environment, cost and the like, a mixed solution of water and alcohol may be used, and it is preferred to use only water.

The concentration of the block copolymer 10 in the organic solvent is only required to be basically within a range in which fusion between the vesicles does not occur, but it can usually be 0.05 w/v % or more and 15 w/v % or less, and is preferably 0.1 w/v % or more and 10 w/v % or less, more preferably 0.2 w/v % or more and 5 w/v % or less, still more preferably 0.5 w/v % or more and 4 w/v % or less, particularly preferably 1 w/v % or more and 3 w/v % or less, and most preferably 2 w/v %.

A mixing ratio of the aqueous solvent to the organic solvent can be 60/40 or more and 99/1 or less in terms of volume ratio, and is preferably 70/30 or more and 97/3 or less, more preferably 80/20 or more and 95/5, still more preferably 85/15 or more and 93/7 or less, and particularly preferably 90/10.

When the mixing ratio is in the above range, the stable vesicle 50 can be formed.

Subsequently, in the step (2), the sol-gel reaction of the silica sauce is carried out using the vesicle 50 as the template in the presence of the aqueous solvent. Thus, the silica 11 can be precipitated on the shell layer 22 of the vesicle 50. The polyamine chain 2 contained in the shell layer 22 of the vesicle 50 functions as the catalyst and the scaffold for the sol-gel reaction of the silica source, and forms the hybrid structure at the molecular level containing the block copolymer 10 and the silica 11. Further, after the silica is precipitated, the hollow nano-particle 100 can contain polysilsesquioxane by further carrying out the sol-gel reaction using the organic silane. Examples of the organic silane include those similar to those exemplified in the above description of the silica.

As a method for carrying out the sol-gel reaction, the hollow nano-particle 100 can be easily obtained by mixing the dispersion liquid of the vesicle 50 and the silica source. Examples of the silica source include those similar to those exemplified in the above description of the silica.

The sol-gel reaction does not occur in a continuous phase of the solvent and proceeds selectively only in the shell layer 22 of the vesicle 50. Therefore, reaction conditions are arbitrary as long as the vesicle 50 is not disassembled.

In the sol-gel reaction, an amount of silica sauce relative to an amount of vesicle 50 is not particularly limited. A ratio of the vesicle 50 and the silica source can be appropriately set according to composition of the desired hollow nano-particle 100.

The content of the silica in the obtained hollow nano-particle 100 can be generally 10% by mass or more and 95% by mass or less of the whole hollow nano-particle, and is preferably 20% by mass or more and 90% by mass or less. The content of the silica can be changed by changing the content of the polyamine chain 2 in the block copolymer 10 used in the sol-gel reaction, the amount of vesicles, the type and amount of the silica source, time and temperature of the sol-gel reaction, or the like.

Further, when the structure of polysilsesquioxane is introduced into the hollow nano-particle 100 using the organic silane after silica precipitation, the amount of organic silane is preferably 50% by mass or less with respect to the amount of the silica source, and more preferably 30% by mass or less.

The temperature of the sol-gel reaction is not particularly limited, and is for example preferably 0° C. or higher and 90° C. or lower, and more preferably 10° C. or higher and 40° C. or lower. From the viewpoint of efficiently producing the hollow nano-particle 100, the reaction temperature is still more preferably 15° C. or higher and 30° C. or lower.

The time of the sol-gel reaction varies from 1 minute to several weeks and can be selected arbitrarily, but in the case of water glass, or methoxysilanes having high reaction activity of alkoxysilane, the reaction time can be 1 minute or more and 24 hours or less, and is preferably 30 minutes or more and 5 hours or less in order to increase reaction efficiency. Further, in the case of ethoxysilanes and butoxysilanes having low reaction activity, the time of the sol-gel reaction is preferably 5 hours or more, and is also preferably about one week. The time of the sol-gel reaction with the organic silane is preferably 3 hours or more and 1 week or less depending on the temperature of the reaction.

The hollow nano-particles 100 obtained by the above production method do not aggregate with each other, have a uniform particle diameter, and have a high porosity of 20% by volume or more. The particle diameter distribution of the hollow nano-particle 100 to be obtained varies depending on production conditions and the desired particle diameter, but can be ±15% or less of the desired particle diameter (average particle diameter), and is preferably ±10% or less.

Further, the hollow nano-particle 100 containing polysilsesquioxane can exhibit excellent monodispersity and have high sol stability in the solvent. Moreover, even if it dries, it can be redispersed in a medium again. This is a characteristic significantly different from that of the conventional hollow nano-particle that it is difficult to be redispersed in the form of particle once the conventional hollow nano-particle in the dispersion liquid is dried. In the case of silica fine particle obtained by the conventional Stober method or the like, redispersibility in the medium is low unless the surface of the obtained fine particle is chemically modified with a substance such as a surfactant, and secondary aggregation and the like occur by drying, and thus it is often necessary to perform pulverization treatment or the like to obtain nano-level ultrafine particle.

Further, the hollow nano-particle 100 can highly concentrate and adsorb metal ions by the polyamine chain 2 present in the matrix of the silica 11 of the shell layer 20. Further, since the polyamine chain 2 is cationic, the hollow nano-particle 100 can also adsorb and immobilize various ionic substances such as anionic biomaterials. Furthermore, the hydrophobic organic chain 1 in the block copolymer 10 can be variously selected according to its functionality, and its structure can be easily controlled, so that various functions can be imparted.

Examples of addition of the function include immobilization of a fluorescent substance and the like. For example, when a small amount of the fluorescent substance, pyrenes, porphyrins and the like are introduced into the polyamine chain 2, a functional residue thereof is incorporated into the shell layer 20 of the hollow nano-particle 100. Further, by using a mixture in which a small amount of a fluorescent dye such as porphyrins, phthalocyanines, pyrenes having an acidic group, for example, a carboxylic acid group or a sulfonic acid group is mixed in the base of the polyamine chain 2, the fluorescent substances can be incorporated into the shell layer 20 of the hollow nano-particle 100. Similarly, by selectively immobilizing the functional substance to the hydrophobic organic chain 1 to form the vesicle and precipitating the silica 11, the functional substance can also be selectively incorporated into the shell layer 20 of the hollow nano-particle 100.

The hollow nano-particle 100 can be dried and used as a powder, and can also be used as a filler for other compounds such as resins. It is also possible to add the dried powder to other compounds as a dispersion or sol obtained by redispersing the powder in the solvent.

### <Hollow Silica Nano-Particle>

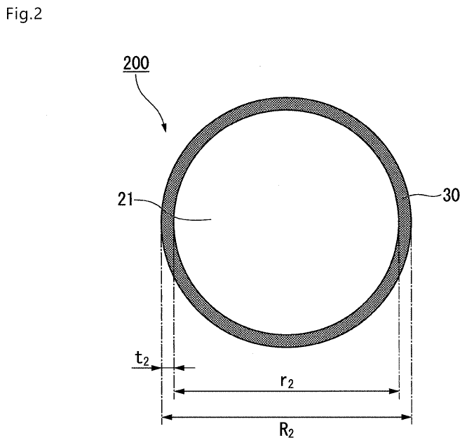

FIG. 2 is a cross-sectional view of the hollow silica nano-particle according to the embodiment of the present invention.

A hollow silica nano-particle 200 includes a shell layer 30 containing silica, and the inside covered with the shell layer 30 is the cavity 21 and has the hollow structure.

The porosity of the hollow silica nano-particle 200 is 20% by volume or more and 70% by volume or less, preferably 20% by volume or more and 60% by volume or less, more preferably 20% by volume or more and 50% by volume or less, still more preferably 25% by volume or more and 40% by volume or less, particularly preferably 27% by volume or more and 30% by volume or less, and most preferably 28% by volume. When the porosity is at least the above lower limit value, the refractive index and the dielectric constant can be made lower and the weight can be made lighter. On the other hand, when it is not more than the above upper limit value, the mechanical strength of the hollow silica nano-particle can be made better.

The porosity can be calculated by using the same method as a porosity calculation method described for the hollow nano-particle, and by respectively replacing R₁ with R₂ and t₁ with t₂ in the above formula.

The thickness t₂ of the shell layer 30 of the hollow silica nano-particle 200 is 3 nm or more and 100 nm or less, preferably 3 nm or more and 50 nm or less, more preferably 5 nm or more and 40 nm or less, still more preferably 5 nm or more and 20 nm or less, particularly preferably 7 nm or more and 15 nm or less, and most preferably 8 nm. When the thickness t₂ of the shell layer 30 is at least the above lower limit value, the mechanical strength of the hollow silica nano-particle can be made better. On the other hand, when it is not more than the above upper limit value, the porosity can be kept higher.

The average value of the particle diameter R₂ (that is, the average particle diameter) of the hollow silica nano-particle 200 is preferably 20 nm or more and 1000 nm or less, more preferably 20 nm or more and 500 nm or less, still more preferably 20 nm or more and 300 nm or less, particularly preferably 20 nm or more and 100 nm or less, and most preferably 46 nm. When the average particle diameter is at least the above lower limit, the porosity can be kept higher. On the other hand, when it is not more than the above upper limit value, the mechanical strength of the hollow silica nano-particle can be made better.

The particle diameter R₂ of the hollow silica nano-particle 200 can be measured by using the same method as the particle diameter R₁ of the hollow nano-particle 100.

Further, since the hollow silica nano-particle 200 is produced from the hollow nano-particle 100 as described in the production method described below, the particle diameter R₁ and the thickness t₁ of the hollow nano-particle 100 are appropriately adjusted, so that the particle diameter R₂ and the thickness t₂ of the hollow silica nano-particle 200 can be controlled within the above range.

The hollow silica nano-particle 200 can be obtained by removing the block copolymer 10 contained in the shell layer 20 of the hollow nano-particle, as will be described below. Therefore, since a portion where the block copolymer 10 is present becomes a micropore, a plurality of micropores are present on the surface of the shell layer 30, and at least a part of the micropores forms a communication hole communicating with the cavity 21 inside the particle. Therefore, in the hollow silica nano-particle 200, the density of silica in the shell layer 30 is appropriately reduced, and the weight of the hollow silica nano-particle 200 is lighter than that of the conventional hollow silica nano-particle.

Examples of the silica constituting the shell layer 30 include those similar to the silica contained in the shell layer 20 of the hollow nano-particle 100.

### <Production Method for Hollow Silica Nano-Particle>

The hollow silica nano-particle according to the embodiment can be produced using the above hollow nano-particle. Therefore, a production process until the hollow nano-particle is obtained will be omitted because it overlaps the production method of the hollow nano-particle. The production method for the hollow silica nano-particle will be described with reference to FIG. 3.

### [Removal Process]

In a removal process, the block copolymer 10 is removed from the hollow nano-particle 100. By removing the block copolymer 10, a desired hollow silica nano-particle 200 can be obtained.

Examples of a method for removing the block copolymer 10 include a firing treatment method and a solvent cleaning method, however, since the block copolymer 10 can be completely removed, the firing treatment method in a firing furnace is preferred.

In the firing treatment, high-temperature firing in the presence of air or oxygen and high-temperature firing in the presence of an inert gas such as nitrogen or helium can be used, but firing in air is usually preferred.

Since the block copolymer 10 is thermally decomposed from around 300° C., the firing temperature is preferably 300° C. or higher, and the firing is preferably performed in a range of 300° C. or higher and 1000° C. or lower, more preferably in the range of 400° C. or higher and 800° C. or lower, still more preferably in the range of 500° C. or higher and 700° C. or lower, particularly preferably in the range of 550° C. or higher and 650° C. or lower, and most preferably at 600° C.

When the hollow nano-particle 100 containing polysilsesquioxane in the shell layer 20 is fired, it is not particularly limited as long as it is fired at a temperature or below at which the polysilsesquioxane is thermally decomposed. For example, when the hollow nano-particle 100 containing polysilsesquioxane in the shell layer 20 is fired at 400° C., the block copolymer 10 can be removed, and the hollow silica nano-particle 200 still containing polysilsesquioxane in the shell layer 30 can be produced.

According to the production method for the hollow silica nano-particle, the hollow silica nano-particle having excellent monodispersity and having a porosity controlled in the above range can be obtained. This is the hollow silica nano-particle having a high porosity of 20% by volume or more, which cannot be obtained by a conventional production method for producing a nano-sized hollow silica particle, for example, a production method for the hollow silica particle using a polymer latex nano-particle or a block polymer micelle as the template. Further, the shell layer of the obtained hollow silica nano-particle may also contain polysilsesquioxane.

Further, since the production method for the hollow silica nano-particle can be performed in water in a short time as described above, it is an environment-friendly production method. Further, preparation of the dispersion liquid of the vesicle 50 of the block copolymer 10 and removal of the block copolymer 10 from the hollow nano-particle 100 can be easily performed using general-purpose equipment, and thus the production method for the hollow silica nano-particle is highly useful.

Further, the hollow silica nano-particle obtained by the above production method can be used as the powder, and can also be used as the filler for other compounds such as resins. It is also possible to add the dried powder to other compounds as the dispersion or the sol obtained by redispersing the powder in the solvent.

Further, the hollow silica nano-particle obtained by the above production method has great expectations for its application regardless of the type of industry or field. The hollow silica nano-particle is a particularly useful material in the fields of antireflection, low dielectric constant, heat insulating materials, and drug delivery systems. Further, the hollow silica nano-particle obtained by the above production method can be used as a stable reaction field for obtaining, for example, crystalline inorganic compounds with a complicated structure having weak moisture resistance (solvent resistance), such as a crystalline nano luminescent material (quantum dot; QD).

### EXAMPLES

Hereinafter, the present invention will be described with reference to Examples, but the present invention is not limited to the following Examples.

### <Measuring Method of Physical Properties of Block Copolymer>

### [Number Average Molecular Weight and Weight Average Molecular Weight]

The number average molecular weight (Mn) and the weight average molecular weight (Mw) of the block copolymer obtained in a synthesis example were measured by the GPC method under the following conditions.

### (Measurement Conditions)

Measuring device: High-speed GPC device (“HLC-8220GPC” manufactured by Tosoh Corporation)
Column: The following columns manufactured by Tosoh Corporation were connected in series and used.
“TSKgel G5000” (7.8 mm I.D.×30 cm)×1 piece
“TSKgel G4000” (7.8 mm I.D.×30 cm)×1 piece
“TSKgel G3000” (7.8 mm I.D.×30 cm)×1 piece
“TSKgel G2000” (7.8 mm I.D.×30 cm)×1 piece

### Detector: RI (Differential Refractometer)

Column temperature: 40° C.
Eluent: tetrahydrofuran (THF)
Flow rate: 1.0 mL/min
Injection volume: 100 μL (tetrahydrofuran solution with a sample concentration of 0.4% by mass)
Standard sample: A calibration curve was prepared using the following standard polystyrene.
(Standard polystyrene)
“TSKgel standard polystyrene A-500” manufactured by Tosoh Corporation
“TSKgel standard polystyrene A-1000” manufactured by Tosoh Corporation
“TSKgel standard polystyrene A-2500” manufactured by Tosoh Corporation
“TSKgel standard polystyrene A-5000” manufactured by Tosoh Corporation
“TSKgel standard polystyrene F-1” manufactured by Tosoh Corporation
“TSKgel standard polystyrene F-2” manufactured by Tosoh Corporation
“TSKgel standard polystyrene F-4” manufactured by Tosoh Corporation
“TSKgel standard polystyrene F-10” manufactured by Tosoh Corporation
“TSKgel standard polystyrene F-20” manufactured by Tosoh Corporation
“TSKgel standard polystyrene F-40” manufactured by Tosoh Corporation
“TSKgel standard polystyrene F-80” manufactured by Tosoh Corporation
“TSKgel standard polystyrene F-128” manufactured by Tosoh Corporation
“TSKgel standard polystyrene F-288” manufactured by Tosoh Corporation
“TSKgel standard polystyrene F-550” manufactured by Tosoh Corporation

### [Amount of Residual Monomer]

The solution of the polymer obtained in the synthesis example was measured using gas chromatography (“GC-2014F type” manufactured by Shimadzu Corporation) under the following conditions to determine an amount of residual monomer.

### (Measurement Conditions)

Column: Wide bore capillary column manufactured by Shimadzu Corporation
Detector: FID (hydrogen flame ionization detector)
Column temperature: 70 to 250° C.
Injection volume: 1 μL (diluted tetrahydrofuran solution)

[¹³C-NMR Spectrum]

Measurement was performed using deuterated chloroform as a solvent using NMR (“ECA-500 type” manufactured by JEOL Ltd.).

### [Synthesis Example 1] Synthesis of St-DM-1

### (Preparation of 1.5M Styrene Solution)

39.1 g (43.1 mL) of styrene (hereinafter abbreviated as “St”) and 206.9 mL of tetrahydrofuran (hereinafter abbreviated as “THF”) were collected using a syringe in a 300 mL eggplant flask replaced with argon gas and stirred, to prepare 250 mL of a 1.5 M solution of St.

### (Preparation of 1.5M Dimethylaminoethyl Methacrylate Solution)

47.2 g (50.4 mL) of dimethylaminoethyl methacrylate (hereinafter abbreviated as “DM”) and 149.6 mL of THF were collected using a syringe in a 300 mL eggplant flask replaced with argon gas and stirred, to prepare 200 mL of a 1.5 M solution of DM.

(Preparation of 0.05M n-Butyllithium Solution)

147.1 mL of hexane was collected using a syringe in a 200 mL eggplant flask replaced with argon gas, and then ice-cooled. After cooling, 2.9 mL of a 2.6 M n-butyllithium solution was collected and stirred, to prepare 150 mL of a 0.05 M solution of n-butyllithium.

### (Preparation of 0.05M Diphenylethylene Solution)

0.901 g (0.9 mL) of diphenylethylene and 149.1 mL of THF were collected using a syringe in a 200 mL eggplant flask replaced with argon gas and stirred, to prepare 150 mL of a 0.05 M solution of diphenylethylene.

### (Preparation of 0.33M Methanol Solution)

0.53 g (0.64 mL) of methanol and 49.4 mL of THF were collected using a syringe in a 100 mL eggplant flask replaced with argon gas and stirred, to prepare 50 mL of a 0.33 M solution of methanol.

### (Synthesis of St-DM-1)

Living anionic copolymerization of St and DM was carried out by the following operation. Four syringe pumps (“syringe pump Model 11 Plus” manufactured by Harvard Apparatus Inc.) were connected to a microreactor device, which is equipped with a micromixer including three T-shaped tube joints and a tube reactor connected downstream of the micromixer, and 50 mL gust syringes respectively having sucked the four types of solutions obtained above were set in the syringe pumps. From the upstream of the reactor including the micromixer with a tube joint diameter of 250 μm and the tube reactor with an inner diameter of 1 mm and a length of 100 cm, St solution was fed at a rate of 6.7 mL/min and n-butyllithium solution was fed at a rate of 4 mL/min to be mixed, to carry out living anionic polymerization of St. Subsequently, from the upstream of the reactor including the micromixer with a tube joint diameter of 500 μm and the tube reactor with an inner diameter of 1 mm and a length of 100 cm, the obtained St polymerization solution and diphenylethylene solution were fed at a rate of 4 mL/min and mixed, to carry out a reaction between a reaction initiation end of St and diphenylethylene. The polymerization of St and the reaction of diphenylethylene were carried out by immersing the tube in a water bath at 25° C. Subsequently, from the upstream of the reactor including the micromixer with a tube joint diameter of 500 μm and the tube reactor with an inner diameter of 1 mm and a length of 200 cm, the obtained reaction solution of St with diphenylethylene and the DM solution were fed at a rate of 1.5 mL/min and mixed, to carry out living anion copolymerization of St and DM. The polymerization of DM was carried out by immersing the tube in a water bath at −27° C. The polymerization reaction was stopped by putting the obtained polymer solution into a bottle containing a predetermined amount of methanol solution, to obtain a polymer (St-DM-1) solution. Note that the reaction temperature was adjusted to 25° C. by burying the entire microreactor in a constant temperature bath. From the amount of residual monomer in the obtained polymer solution, the reaction ratio (polymer conversion rate) of St was 99.8% by mass, and the reaction ratio (polymer conversion rate) of DM was 59.8% by mass. Further, the number average molecular weight (Mn) of the obtained polymer was 7,018, the weight average molecular weight (Mw) was 8,150, and the dispersity (Mw/Mn) was 1.16. Note that from the ¹³C-NMR spectrum, the polymer St-DM-1 obtained was a compound represented by the following formula (1). In the formula (1), m/n is 50/11.2.

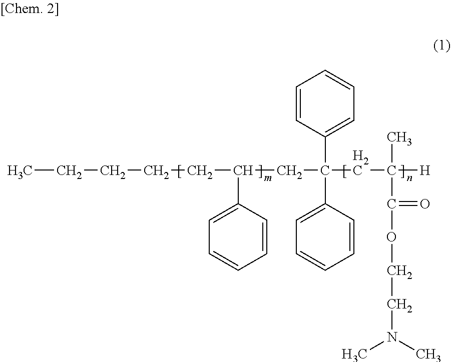

### <Measurement Method of Physical Properties of Hollow Nano-Particle and Hollow Silica Nano-Particle>

### [Thermogravimetric Analysis (TGA) Measurement]

Powders of the hollow nano-particle obtained in Examples and the core-shell type nano-particle obtained in Comparative Example were measured by TGA (device: TG/DTA6300 manufactured by SII Nanotechnology Co., Ltd.), and the composition of the particle was estimated by mass reduction in the range of 150° C. or higher and 800° C. or lower.

[Observation with Transmission Electron Microscope (TEM)]

The dispersion liquids of the hollow nano-particle, the core-shell type nano-particle, and the hollow silica nano-particle obtained in Examples and Comparative Example were diluted with ethanol, placed on a carbon-deposited copper grid, and the sample was observed by TEM (JEM-2200FS manufactured by JEOL Ltd.). For the hollow nano-particle and the hollow silica nano-particle obtained in Examples, from the TEM image, a diameter of the cavity (that is, an inner diameter of the particle), the thickness of the shell layer, and the particle diameter (that is, the outer diameter of the particle) of 50 particles were measured, and the average values were calculated. Further, similarly for the core-shell type nano-particle obtained in Comparative Example, the diameter of the core layer, the thickness of the shell layer, and the particle diameter of 50 particles were measured, and the average values were calculated. Similarly for the hollow silica nano-particle obtained in Comparative Example, the diameter of the cavity (that is, the inner diameter of the particle), the thickness of the shell layer, and the particle diameter (that is, the outer diameter of the particle) of 50 particles were measured, and the average values were calculated.

### [Porosity]

From the TEM image of the hollow nano-particle, core-shell type nano-particle, and hollow silica nano-particle (50 each) obtained in Examples and Comparative Example, by measuring the particle diameter and the thickness of the shell layer of each particle, the volume of the particle and the volume of the void were calculated, and the ratio (volume %) of the volume of the particle to the volume of the void was calculated as the porosity.

### Example 1

### (Production of Hollow Nano-Particle)

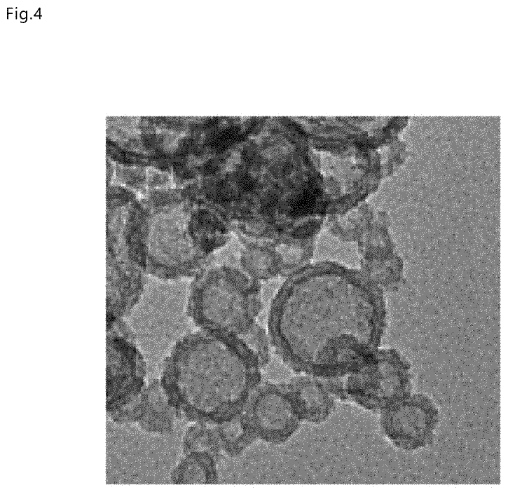

45 mL of distilled water was added dropwise to a 5 mL St-DM-1 THF solution (2.0 w/v %) with stirring, and the mixture was further stirred at room temperature for 24 hours to obtain a dispersion liquid of polymer vesicles. To the dispersion liquid of polymer vesicles, 0.50 mL of a tetramer of methoxysilane (produced by Mitsubishi Chemical Corporation, “MKC (registered trademark) silicate (trade name)”, grade: MS51) was added as the silica source. The obtained dispersion liquid was stirred at room temperature for 3 hours, washed with ethanol, and dried to obtain 0.26 g of powder. Estimated from the TGA measurement data, the content rate of the organic component in the powder was 40% by mass. By TEM observation (see FIG. 4), the obtained powder was a hollow particle having a cavity of 30 nm, a shell layer of 10 nm, an average particle diameter of 50 nm, and the porosity was 22% by volume.

### Example 2

### (Production of Hollow Silica Nano-Particle)

0.1 g of the polymer/silica hybrid hollow particle obtained in Example 1 was added to an alumina crucible, and the particle was fired in an electric furnace. As the electric furnace, a firing furnace apparatus (ceramic electric tube furnace ARF-100K type manufactured by Asahi Rika Seisakusho Co., Ltd. with AMF-2P type temperature controller) was used. The temperature inside the furnace was raised to 600° C. over 5 hours and maintained at the temperature for 3 hours. This was naturally cooled to remove polymer components. The yield was 0.055 g. By TEM observation, the obtained hollow silica particle had a hollow structure, the central cavity was 30 nm, the thickness of the shell layer was 8 nm, the average particle diameter was 46 nm, and the porosity was 28% by volume.

### Comparative Example 1

### (Production of Hollow Silica Nano-Particle)

Core-shell type silica nano-particle was produced according to a method described in Reference 2 (JP-A-2014-077047). Specifically, the procedure described below was performed.

First, a copolymer (A-1) was synthesized. 1.5 g of branched chain polyethyleneimine (SP018 produced by Nippon Shokubai Co., Ltd., average molecular weight 1800) and 0.5 g of glycidyl hexadecyl ether (reagent available from Aldrich, hereinafter referred to as EP-C16) were dissolved in 40 mL of ethanol. The reaction was carried out at 75° C. for 24 hours. Ethanol was removed and vacuum dried at 60° C. to obtain the copolymer (A-1). By ¹H-NMR measurement, the signal (3.0-4.0 ppm) derived from the proton adjacent to the ether oxygen was broad, so that formation of the copolymer (A-1) was found.

Subsequently, a mixed solution of 0.05 g of the copolymer (A-1) and 5 mL of water was stirred at 80° C. for 24 hours to obtain an aggregate. To the dispersion liquid of the aggregate, 0.50 mL of a tetramer of methoxysilane (produced by Mitsubishi Chemical Corporation, “MKC (registered trademark) silicate (trade name)”, grade: MS51) was added as the silica source. The obtained dispersion liquid was stirred at room temperature for 4 hours, washed with ethanol, and dried to obtain a powder of core-shell type nano-particle. Estimated from the TGA measurement data, the content rate of the organic component in the powder was 17.3%. By TEM observation, it was found that the obtained powder was the nano-particle having a core-shell structure. The core with a central portion of 3.5 nm is considered to be a hydrophobic organic segment having a relatively low electron density, and looks bright. On the other hand, the 4 nm shell layer is considered to be a complex of an aliphatic polyamine having a high electron density and silica, and looks dark. Further, the shape of the obtained powder was spherical with excellent monodispersity, and the average particle size was about 11 nm.

Subsequently, according to the method described in PTL 4, the core-shell type silica nano-particle was fired to obtain a hollow silica nano-particle. Specifically, 0.1 g of the core-shell type silica nano-particle was added to an alumina crucible, and the particle was fired in an electric furnace. As the electric furnace, the firing furnace apparatus (ceramic electric tube furnace ARF-100K type manufactured by Asahi Rika Seisakusho Co., Ltd. with AMF-2P type temperature controller) was used. The temperature inside the furnace was raised to 600° C. over 5 hours and maintained at the temperature for 3 hours. This was naturally cooled to remove the copolymer (A-1). By TEM observation, the obtained silica nano-particle had a hollow structure, the average particle diameter (average value of the outer diameters of the particles) was about 10 nm, a plurality of 3.0 nm cavities were present in the center, and the porosity was 6% by volume.

### INDUSTRIAL APPLICABILITY

According to the hollow nano-particle, the hollow silica nano-particle, and the production method for the same of the present embodiment, it is possible to provide the hollow nano-particle and the hollow silica nano-particle having excellent monodispersity, a high porosity of 20% by volume or more, and an average particle diameter of nano order.

### REFERENCE SIGNS LIST

1: Hydrophobic organic chain 2: Polyamine chain,
10: Block copolymer, 11: Silica 20: Shell layer
21: Cavity, 22: Shell layer containing block copolymer,
30: Shell layer containing silica, 50: Vesicle containing block copolymer, 100: Hollow nano-particle,
200: Hollow silica nano-particle R₁: Particle diameter (Outer diameter) of hollow nano-particle, R₂: Particle diameter (Outer diameter) of hollow silica nano-particle, r₁: Inner diameter of hollow nano-particle,
r₂: Inner diameter of hollow silica nano-particle,
t₁: Thickness of shell layer of hollow nano-particle,
t₂: Thickness of shell layer of hollow silica nano-particle.

1. A hollow nano-particle comprising a shell layer containing a block copolymer having a hydrophobic organic chain and a polyamine chain, and silica.

2. The hollow nano-particle according to claim 1, having a porosity of 20% by volume or more and 70% by volume or less.

3. The hollow nano-particle according to claim 1, having an average particle diameter of 20 nm or more and 1000 nm or less.

4. The hollow nano-particle according to claim 1, having a thickness of the shell layer of 3 nm or more and 100 nm or less.

5. (canceled)

6. (canceled)

7. A production method for the hollow nano-particle according to claim 1, the production method comprising:
a step of dropping an aqueous solvent while stirring an organic solvent in which a block copolymer having a hydrophobic organic chain and a polyamine chain is dissolved, to obtain a dispersion liquid of vesicles containing the block copolymer; and
a step of adding a silica source to the dispersion liquid of vesicles, carrying out a sol-gel reaction of the silica source using the vesicle as a template, and precipitating silica to obtain the hollow nano-particle.

8. A production method for a hollow silica nano-particle having a porosity of 20% by volume or more and 70% by volume or less and a thickness of a shell layer containing silica of 3 nm or more and 100 nm or less, the production method comprising:
a step of dropping an aqueous solvent while stirring an organic solvent in which a block copolymer having a hydrophobic organic chain and a polyamine chain is dissolved, to obtain a dispersion liquid of vesicles containing the block copolymer;
a step of adding a silica source to the dispersion liquid of vesicles, carrying out a sol-gel reaction of the silica source using the vesicle as a template, and precipitating silica to obtain a hollow nano-particle; and
a step of removing the block copolymer from the hollow nano-particle.

9. The production method according to claim 8, wherein removal of the block copolymer is by firing.

10. The production method according to claim 8, wherein the hollow silica nano-particle has an average particle diameter of 20 nm or more and 1000 nm or less.

11. The production method according to claim 9, wherein the hollow silica nano-particle has an average particle diameter of 20 nm or more and 1000 nm or less.
